(19) United States
(12) Patent Application Publication
(10) Pub. No.: US 2026/0028292 A1
(43) Pub. Date: Jan. 29, 2026

(54) BIOCHAR-BASED ORGANIC FERTILIZER, PREPARATION METHOD AND USE METHOD THEREOF

(71) Applicant: Zhejiang University of Science and Technology, Hangzhou (CN)

(72) Inventors: Cheng LIU, Hangzhou (CN); Shengdao SHAN, Hangzhou (CN); Shijie SHANG, Hangzhou (CN); Zichuan LI, Hangzhou (CN); Yanjun CHAI, Hangzhou (CN)

(21) Appl. No.: 18/904,208

(22) Filed: Oct. 2, 2024

(30) Foreign Application Priority Data
Jul. 26, 2024 (CN) 202411016678.9

(51) Int. Cl. C05F 11/08; C05F 3/00; C05F 17/50; C05F 17/60

(52) U.S. Cl. CPC C05F 11/08; C05F 3/00; C05F 17/50; C05F 17/60

(57) ABSTRACT

Disclosed are a biochar-based organic fertilizer, a preparation method and a use method thereof, belonging to the technical field of organic fertilizer preparation. The biochar-based organic fertilizer includes the following raw materials: pig manure, biochar of corn straws, mixed straws, mineral catalyst and a microbial decomposing agent, and is prepared by mixing the raw materials for aerobic fermentation composting. Through the adsorption and binding reaction of biochar with manure nutrients and activated by microbial decomposing agent-mineral catalyst, the microbial growth and the activity of microorganisms are stimulated by the structure of biochar and some of the active organic substances.

### CROSS-REFERENCE TO RELATED APPLICATIONS

This application claims priority to Chinese Patent Application No. 202411016678.9, filed on Jul. 26, 2024, the contents of which are hereby incorporated by reference.

### TECHNICAL FIELD

The present disclosure relates to the technical field of organic fertilizer preparation, and in particular to a biochar-based organic fertilizer, a preparation method and a use method thereof.

### BACKGROUND

It is in good forest ecosystem and high-quality woodland soil that ginseng will grow well. However, the old ginseng land has been commonly affected by continuous cropping obstacles, such as serious diseases, fibrous root withering and root rot. In particular, root rot has been a major problem for ginseng cultivation in old ginseng land, causing yearly reduction of ginseng field resources. Studies have indicated that the main cause of obstacles in continuous cropping of ginseng is the upsurge in the abundance of pathogenic microorganisms in the inter-root soil, which infect ginseng root system and cause root rot disease.

Therefore, a biochar-based organic fertilizer for controlling soil-borne diseases of ginseng is urgently required, which is of great importance for improving soil biological health and ginseng quality under the stress of ginseng continuous cropping.

### SUMMARY

In order to solve the technical problems, the present disclosure provides a biochar-based organic fertilizer, a preparation method and a use method thereof. By adsorption and binding reaction between biochar and manure nutrients, and by activation of microbial decomposing agent-mineral catalyst, the growth of microorganisms and their activity are stimulated by the structure of biochar and part of the active organic matter to achieve rapid composting, and the products are loaded onto the biochar, thus obtaining a clean organic fertilizer, which is granular and has a porous and loose structure. The biochar-based organic fertilizer effectively solves the problems of high morbidity, lower yield and lower quality of ginseng cultivation caused by soil-borne diseases in the prior art by increasing soil organic matter, improving soil structure, increasing microbial diversity and decreasing the abundance of pathogenic bacteria.

In order to achieve the above objectives, the present disclosure provides the following technical scheme.

One of the technical schemes of the present disclosure is as follows.

A biochar-based organic fertilizer, including raw materials of pig manure, biochar of corn straws, mixed straws, a mineral catalyst and a microbial decomposing agent.

In an embodiment of the present disclosure, a mass ratio of the pig manure, the biochar of corn straws, the mixed straws, the mineral catalyst and the microbial decomposing agent is 100:(30-40):20:1:0.1.

In an embodiment, the mineral catalyst is fine zeolite minerals, obtained by grinding zeolite and then sieving with a 60-mesh sieve.

In an embodiment, preparation steps of the biochar of corn straws include:
subjecting corn straws to high-temperature carbonization under anaerobic conditions, followed by cooling, grinding and sieving to obtain the biochar of corn straws.

In an embodiment, in a process of the high-temperature carbonization, the corn straws are heated from room temperature, at a heating rate of 5 degrees Celsius per minute (C/min), to 450° C., and held for 180 min.

In an embodiment, the sieving is sieving through a 10-20 mesh sieve.

In an embodiment, a pore size of the biochar of corn straws is 0.029 cubic centimeter per gram (cm³·g⁻¹), with a surface area of 14.56 square meter per gram (m²·g⁻¹), a pH of 9.95, and an organic carbon content of 463.63 g·kg⁻¹ (biochar of corn straws prepared in Embodiment 1 of the present disclosure).

In an embodiment, the mixed straws include corn straws, rice straws and wheat straws.

In an embodiment, the mixed straws include, in parts by weight, 30-50 parts of wheat straws, 20-40 parts of rice straws and 20-40 parts of corn straws.

Another technical scheme of the present disclosure:
a preparation method of the biochar-based organic fertilizer includes the following steps:
performing aerobic composting fermentation to uniformly mixed raw materials to prepare the biochar-based organic fertilizer.

In an embodiment, a specific process of the aerobic composting fermentation is as follows:
initial heating period, with a temperature lower than 50° C., and a pile is turned over every 2 days for 5-7 days;
high temperature period, where the temperature reaches 50-70° C., and the pile is turned over every 1-2 days for 7-12 days; and
cooling period, where the temperature is below 55° C., and the pile is turned every 2-3 days for 5-7 days.

The beneficial effects achieved by the above technical schemes are as follows.

The biochar in the present disclosure is a highly aromatic solid carbon-rich material made from corn straws under anaerobic conditions by thermal cracking at low and medium temperatures, featuring rich content of stabilized organic matter, high pH, and abundant pore space, and the biochar of corn straws is effective in elevating the pH of the soil, increasing the content of organic matter, improving the structure of the soil, and stimulating the microbial activity by improving the microbial habitats. Using the pore structure and surface area of the biochar, adsorption and binding reactions take place with the nutrients of the manure, and the toxic substances of the manure are decomposed by the composting microorganisms at high temperatures (50-70° C.), and the released nitrogen is adsorbed and bound by the biochar instead of forming the odorous nitrogen oxides. This process is activated by the microbial decomposing agent-mineral catalysts, where the structure of the biochar and the active organic matter stimulate the growth of microorganisms and their activity to achieve rapid composting, and the product is loaded onto the biochar to produce a clean organic fertilizer with a granular, porous and loose structure, which has a significant effect on the rapid enhancement of the organic matter in the soil of continuous ginseng cultivation, the management of soil crusting and the restoration of the soil microbial activity, as well as a remarkable increase in ginseng yield and optimization.

Another technical scheme of the present disclosure provides a use method of the above-mentioned biochar-based organic fertilizer, including applying the biochar-based organic fertilizer to soils of a continuous cropping ginseng field at 10 tons per hektare (t·ha⁻¹).

Compared with the prior art, the present disclosure has the following advantages and technical effects.

The present invention adopts low-cost corn straws as raw material and obtains biochar material rich in high organic carbon and good pore structure through medium-temperature thermal cracking under anaerobic conditions, and then mixed with fresh pig manure, mixed straws, fine zeolite minerals and microbial decomposing agent to carry out aerobic composting and fermentation, so as to obtain clean biochar-based organic fertilizer with loose and porous structure.

The preparation method of the present disclosure is easy to operate, inexpensive, and makes full use of agricultural waste as the raw material for preparing organic fertilizer; the biochar-based organic fertilizer produced by the preparation method is applied to the soil with biobarrier of serious soil-borne diseases, and is capable of increasing the content of soil organic matter and molecular diversity, improving the soil structure, increasing the abundance of soil microorganisms and the network interoperation capability, which is green and environmentally friendly; it is also effective in reducing the accumulation of phenolic chemosensory substances in ginseng root secretion, such as reducing the content of vanillic acid, butyric acid, 4-hydroxybenzoic acid and benzoic acid in the root secretion; moreover, by increasing soil microbial diversity and network complexity and reducing the abundance of the pathogenic fungus Fusarium, the activity of soil beneficial microorganisms is further activated to antagonize soil-borne pathogens, thus effectively decreasing the chances of soil-borne pathogenic microorganisms infesting the root system of the crops, improving the survival rate of the crops, and realizing the prevention and control of soil-borne diseases.

### BRIEF DESCRIPTION OF THE DRAWINGS

The accompanying drawings, which constitute a part of this application, are used to provide a further understanding of this application. The illustrative embodiments of this application and the descriptions thereof are used to explain this application, and do not constitute an improper limitation of this application. In the attached drawings:

FIG. 1A is a diagram showing the influence of the organic fertilizers in the control group and Embodiments 1-3 on the community structure of bacteria in the continuous cropping ginseng soil;

FIG. 1B is a diagram showing the influence of the organic fertilizers in the control group and Embodiments 1-3 on the community structure of fungi in the continuous cropping ginseng soil;

FIG. 2 shows the influence of organic fertilizer on the survival rate of continuous cropping ginseng in control group and Embodiments 1-3;

FIG. 3 shows the influence of organic fertilizer on the ginsenoside content of continuous cropping ginseng in the control group and Embodiments 1-3;

FIG. 4A shows a scanning electron microscope (SEM) diagram of biochar of corn straws prepared in Embodiment 1 of the present disclosure with scales of 500 μm.

FIG. 4B shows an SEM diagram of biochar of corn straws prepared in Embodiment 1 of the present disclosure with scales of 200 μm.

FIG. 4C shows an SEM diagram of biochar of corn straws prepared in Embodiment 1 of the present disclosure with scales of 50 μm.

### DETAILED DESCRIPTION OF THE EMBODIMENTS

A number of exemplary embodiments of the present disclosure are now described in detail, and this detailed description should not be considered as a limitation of the present disclosure, but should be understood as a more detailed description of certain aspects, characteristics and embodiments of the present disclosure.

It should be understood that the terminology described in the present disclosure is only for describing specific embodiments and is not used to limit the present disclosure. In addition, for the numerical range in the present disclosure, it should be understood that each intermediate value between the upper limit and the lower limit of the range is also specifically disclosed. The intermediate value within any stated value or stated range and every smaller range between any other stated value or intermediate value within the stated range are also included in the present disclosure. The upper and lower limits of these smaller ranges can be independently included or excluded from the range.

Unless otherwise specified, all technical and scientific terms used herein have the same meaning as commonly understood by one of ordinary skill in the art to which this present disclosure relates. Although the present disclosure only describes the preferred methods and materials, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present disclosure without departing from the scope or spirit of the present disclosure. Other embodiments will be apparent to the skilled person from the description of the present disclosure. The description and embodiments of the present disclosure are exemplary only.

The terms “including”, “comprising”, “having” and “containing” used in this specification are all open terms, which means including but not limited to.

The present disclosure provides a preparation method of a biochar-based organic fertilizer for preventing and treating ginseng soil-borne diseases, including the following steps:
(1) selecting biomass materials of corn straws, fully drying and crushing, and drying to a constant weight;
(2) subjecting the above materials to high temperature carbonization under anaerobic conditions, followed by cooling to room temperature, grinding and sieving to obtain a biochar of corn straws;
(3) selecting waste pig manure from pig farm for later use;
(4) collecting mixed straws, including corn straws, rice straws and wheat straws;
(5) selecting a microbial decomposing agent purchased from Shenwei Microbial Strain Technology Co., Ltd. of Yancheng City, Jiangsu Province, China, and sealing for later use; and
(6) selecting zeolite powder produced by Shangtianti Tangwa Mining Co., Ltd. of Xinyang City, Henan Province, China, for later use.

In some preferred embodiments, the corn straws in step (1) are crushed, and then ground and sieved to obtain biomass powder with particle size less than 1 cm.

In some preferred embodiments, a temperature of the high temperature carbonization in step (2) is 450° C., specifically, the temperature is raised from room temperature to 450° C. at a heating rate of 5° C./min, and held at the temperature of 450° C. for 180 min.

In some preferred embodiments, the grinding in step (2) is followed by sieving through a 10-mesh sieve.

In some preferred embodiments, the fresh pig manure in step (3) is aired to a water content of 50%.

In some preferred embodiments, the mixed straws in step (4) includes the following components in parts by weight: 30-50 parts of wheat straws, 20-40 parts of rice straws and 20-40 parts of corn straws, all of which are crushed to below 2 cm.

In some preferred embodiments, the number of effective viable bacteria in the microbial decomposing agent in step (5) is ≥20 billion/g.

In some preferred embodiments, in step (6), the zeolite is ground and then screened by a 60-mesh sieve to obtain fine zeolite minerals.

The method also includes a step (7), including: mixing pig manure, biochar of corn straws, mixed straws, fine zeolite minerals and a microbial decomposing agent according to a mass ratio of 100:30-40:10:1:0.1, and then performing aerobic composting and fermentation in a fermentation tank.

In some preferred embodiments, the pile is turned and mixed using a forklift, with a turner being optimal. The pile is then formed into a pile body and a thermometer is inserted in the center part of the pile body for real time monitoring of the temperature change of the pile body.

In some preferred embodiments, in the aerobic composting process, the pile is turned over in the initial heating period (<50° C., 5-7 days) every 2 days, and turned over every 1-2 days after the temperature changes reach the high temperature period (50-70° C., 7-12 days), and the pile is turned over every 2-3 days when the temperature of the pile reaches the cooling period (<55° C., 5-7 days). The composting fermentation with the addition of biochar reaches adequate fermentation and decomposition after 4 weeks.

In some preferred embodiments, in the fermentation tank, the materials may be turned and tossed by using the turner, so that the materials may be fermented uniformly. In order to enhance the fermentation effect, the bottom of the fermentation tank may be equipped with a blast process, and an aeration pipe may be installed at the bottom of the fermentation tank to forcibly ventilate the reactor to supply oxygen, so as to increase the oxygen content in the reactor and avoid anaerobic reaction caused by lack of oxygen during fermentation.

In some preferred embodiments, the aging treatment (the above cooling period) is carried out, that is, the organic wastes after heating and high-temperature fermentation have not been completely decomposed, and the objective of aging is to further decompose and stabilize some residual organic substances that are difficult to decompose in the material, so that the water content of the material is balanced, and the biochar-based organic fertilizer for the prevention and treatment of soil-borne diseases of ginseng is obtained.

The present disclosure also provides a use method of the biochar-based organic fertilizer, which include the following specific steps:
one week before transplanting ginseng seedlings, the biochar-based organic fertilizer prepared above is applied to the soil of continuous cropping ginseng field according to 10 t·ha⁻¹ to mix with soil; ridging again, and planting ginseng seedlings after standing for one week. The biochar-based organic fertilizer provided by the present disclosure is effective in reducing the incidence of soil-borne diseases in continuous cropping ginseng soil.

All the raw materials used in the embodiments of the present disclosure are obtained by commercial purchase. Fine zeolite minerals used in the following embodiments are purchased from Shangtianti Tangwa Mining Co., Ltd., the microbial decomposition agent is purchased from Shenwei Microbial Strain Technology Co., Ltd.; and the pig manure is selected from waste pig manure from pig farms, with a water content controlled at 50%.

“Parts” used in the embodiments of the present disclosure are all “parts by weight” unless otherwise specified.

The technical schemes of the present disclosure are further explained by embodiments.

### Embodiment 1

The present disclosure relates to a biochar-based organic fertilizer for preventing and treating soil-borne diseases of ginseng, which includes the following raw materials: pig manure, biochar of corn straws, mixed straws, fine zeolite minerals and microbial decomposing agent in a mass ratio of 100:40:20:1:0.1;
among them, the mixed straws include the following raw material components in parts by weight: 30 parts of wheat straws, 20 parts of rice straws and 20 parts of corn straws; and
the preparation steps of the biochar of corn straws are as follows:
after fully airing, corn straws are ground and screened to obtain blocky stalks less than <1 cm; under anaerobic conditions, the blocky stalks are raised from room temperature to 450° C. at a heating rate of 5° C./min, and cooled to room temperature after holding for 180 min; and then the biochar is sieved with a 20-mesh sieve to obtain the biochar of corn straws.

The preparation method of the biochar-based organic fertilizer for preventing and treating soil-borne diseases of ginseng adopts an aerobic composting fermentation method, and specifically includes the following steps:
(1) the pig manure, biochar of corn straws, mixed straws, fine zeolite minerals and microbial decomposing agent are weighed and mixed according to the ratio of the raw materials;
(2) the mixed raw materials are stacked in a shape of cone and placed in a fermentation tank, and an aeration pipeline is installed at the bottom of the fermentation tank to forcibly ventilate the pile and supply oxygen, so as to increase the oxygen content in the pile and avoid anaerobic reaction caused by lack of oxygen in the fermentation process, thus further enhancing the fermentation effect; a normal temperature thermometer is inserted in the center of the pile for monitoring the temperature change of the pile in real time; in the fermentation process, the material is turned and tossed by the turner, so that the material is fermented evenly, and the specific steps are as follows:
heating fermentation: in the initial heating period (<50° C., 7 days), the pile is turned every 2 days;
high-temperature fermentation: after the temperature change reaches the high-temperature period (50-70° C. for 7 days), the pile is turned over every 2 days;
aging treatment: after the temperature of the pile reaches the cooling period (<55° C., 7 days), the pile is turned over once every 3 days to achieve the adequate fermentation and decomposition.

### Embodiment 2

The difference from Embodiment 1 is that the mass ratio of pig manure, biochar of corn straws, mixed straws, fine zeolite minerals and microbial decomposing agent is 100:30:10:1:0.1. Other conditions and steps are the same as in Embodiment 1.

### Embodiment 3

The difference from Embodiment 2 is that the screening is 10 mesh in the process of preparing biochar of corn straws. Other conditions and steps are the same as in Embodiment 2.

### Comparative Embodiment 1

The difference from Embodiment 1 is that fine zeolite minerals are not included in the biochar-based organic fertilizer, and other conditions and steps are the same as Embodiment 1.

### Comparative Embodiment 2

The difference from Embodiment 1 is that the biochar-based organic fertilizer does not include microbial decomposing agent, and other conditions and steps are the same as Embodiment 1.

The quality analysis of the biochar-based organic fertilizer prepared by the above Embodiment 1, Comparative embodiment 1 and Comparative embodiment 2 is shown in Table 1 below.

TABLE 1

| | | Organic | | | Content | |
|---|---|---|---|---|---|---|
| | pH | matters | | Conductivity | of humic | Germination |
| | (H₂O) | (%) | C/N | (mS · cm⁻¹) | acid (%) | index (%) |
| Comparative | 8.14 | 48.8 | 18.1 | 5.6 | 21.2 | 60.4 |
| embodiment 1 | | | | | | |
| Comparative | 8.09 | 46.7 | 21.4 | 6.1 | 18.3 | 62.5 |
| embodiment 2 | | | | | | |
| Embodiment 1 | 8.03 | 52.1 | 16.5 | 3.8 | 27.6 | 73.8 |

### Effect Verification

The field experiment site is in an old ginseng field with serious continuous cropping obstacle cultivated for five years in Xiaoshan Village (41°23′42″N, 127° 32′37″E) in Fusong County, Baishan City, Jilin Province, China. The experimental site is located between the middle temperate zone and the warm temperate zone in the northeast of China with four distinctive seasons. The average annual temperature in Fusong County is 4° C., the average annual sunshine duration is 2,352.5 hours, and the average annual precipitation is about 800 mm, which is abundant. The experimental site was an old ginseng field where ginseng has been planted for five years, and the soil type is dark brown soil. The basic properties of the topsoil: pH (H₂O) of 4.57, soil bulk density of 1.15 g·cm⁻³, organic carbon content of 17.88 g·kg⁻¹, total nitrogen content of 1.29 g·kg⁻¹, available phosphorus content of 13.41 mg·kg⁻¹, rapidly available potassium content of 153.12 mg·kg⁻¹, and cationic exchange of 24.87 cmol·kg⁻¹

Four treatments are set up in the experiment: the control group is the local traditional organic fertilizer (pig manure compost, purchased from Qingdao Di'endi Biotechnology Co., Ltd.), and the application amount is 10 t·ha⁻¹; other treatments are applied with the biochar-based organic fertilizer obtained in Embodiment 1, Embodiment 2 and Embodiment 3, respectively, with the application amount of 10 t·ha⁻¹; each treatment has four replications with a total of 16 plots which are arranged in completely randomized blocks. The area of a single plot is 20 m² (5 m×4 m), and the plots are separated by 20 cm intervals as protection rows to prevent interpenetration. Organic fertilizers are uniformly applied at one time to the soil one week before ginseng transplantation, and fully mixed with the soil within the 0-20 cm arable layer. Healthy and uniformly growing three-year old ginseng seedlings are selected for transplanting at a planting density of 18 plants·m⁻², and field management, such as weeding, is consistent with the local conventional planting management patterns. After two years, the soil and ginseng plants are collected for measurements, and the specific measurements are shown in Tables 2-5.

TABLE 2
Effect of organic fertilizer application on soil properties of continuous
cropping ginseng fields in control group and Embodiments 1-3

| | Control group | Embodiment 1 | Embodiment 2 | Embodiment 3 |
|---|---|---|---|---|
| pH (H₂O) | 4.43 ± 0.16b | 4.72 ± 0.03a | 4.98 ± 0.01a | 4.94 ± 0.07a |
| Bulk density (g · cm⁻³) | 1.06 ± 0.05a | 1.02 ± 0.06ab | 0.97 ± 0.03bc | 0.94 ± 0.01bc |
| Organic carbon (g · kg⁻¹) | 11.34 ± 0.36b | 13.72 ± 0.44a | 13.61 ± 0.79a | 13.56 ± 2.63a |
| Total nitrogen (g · kg⁻¹) | 0.98 ± 0.01a | 1.08 ± 0.18a | 1.09 ± 0.08a | 1.13 ± 0.20a |
| Available phosphorus | 24.79 ± 0.20b | 29.72 ± 2.59a | 34.70 ± 1.45a | 32.45 ± 2.79a |
| (mg · kg⁻¹) | | | | |
| Available potassium | 172.23 ± 11.16b | 208.67 ± 11.87ab | 218.26 ± 18.00a | 234.40 ± 17.09a |
| (mg · kg⁻¹) | | | | |
| Porosity (%) | 60.18 ± 1.81c | 60.18 ± 1.81c | 60.18 ± 1.81c | 60.18 ± 1.81c |
| Cation exchange capacity | 61.54 ± 2.39bc | 61.54 ± 2.39bc | 61.54 ± 2.39bc | 61.54 ± 2.39bc |
| (cmol · kg⁻¹) | | | | |
| Water content (%) | 63.47 ± 0.99ab | 63.47 ± 0.99ab | 63.47 ± 0.99ab | 63.47 ± 0.99ab |
| Conductivity (μS · cm⁻¹) | 65.91 ± 0.37a | 65.91 ± 0.37a | 65.91 ± 0.37a | 65.91 ± 0.37a |
| Microbial biomass carbon | 25.15 ± 0.95a | 25.15 ± 0.95a | 25.15 ± 0.95a | 25.15 ± 0.95a |
| (mg · kg⁻¹) | | | | |
| Microbial biomass | 26.71 ± 1.35a | 26.71 ± 1.35a | 26.71 ± 1.35a | 26.71 ± 1.35a |
| nitrogen (mg · kg⁻¹) | | | | |

TABLE 3
Effect of organic fertilizer application on soil aggregate distribution of
continuous cropping ginseng fields in control group and Embodiments 1-3

| | Control group | Embodiment 1 | Embodiment 2 | Embodiment 3 |
|---|---|---|---|---|
| Clay and | 60.94 ± 4.17b | 52.1 ± 2.03b | 47.87 ± 6.60a | 49.87 ± 2.42a |
| silt <53 (μm) | | | | |
| Micro-aggregates | 15.03 ± 2.42ab | 17.35 ± 0.90b | 17.79 ± 3.12a | 15.40 ± 0.86ab |
| 53-250 (μm) | | | | |
| Macro-aggregates | 24.03 ± 1.75b | 30.55 ± 1.93b | 34.34 ± 1.62a | 34.74 ± 3.11a |
| 250-2000 (μm) | | | | |
| Mean weight | 345.48 ± 20.22c | 377.88 ± 21.09b | 421.89 ± 21.93a | 426.79 ± 33.24a |
| diameter (μm) | | | | |

TABLE 4
Effects of organic fertilizer application in control group and Embodiments 1-3
on soil microbial abundance and diversity of continuous cropping ginseng fields

| | Control group | Embodiment 1 | Embodiment 2 | Embodiment 3 |
|---|---|---|---|---|
| Bacterial gene copy | 3.34 ± 0.31b | 3.99 ± 0.39ab | 4.62 ± 0.29a | 4.28 ± 0.10a |
| number | | | | |
| (×10⁹ copies/g dry | | | | |
| soil) | | | | |
| Fungal gene copy | 2.36 ± 0.42b | 2.73 ± 0.19a | 3.27 ± 0.28a | 2.97 ± 0.21a |
| number | | | | |
| (×10⁸ copies/g dry | | | | |
| soil) | | | | |
| Fusarium oxysporum | 2.11 ± 0.13a | 1.16 ± 0.15b | 1.03 ± 0.11b | 1.01 ± 0.12b |
| Relative abundance | | | | |
| (%) | | | | |
| Bacterial Chao1 Index | 960.40 ± 9.19b | 1032.02 ± 13.13a | 1135.69 ± 14.85a | 1124.89 ± 10.20a |
| Bacterial Shannon | 7.31 ± 0.08b | 8.18 ± 0.02a | 8.22 ± 0.01a | 8.31 ± 0.04a |
| Index | | | | |
| Fungal Chao1 Index | 601.08 ± 31.48a | 648.92 ± 25.87a | 654.23 ± 21.06a | 645.87 ± 17.34a |
| Fungal Shannon Index | 6.76 ± 0.14b | 7.37 ± 0.08a | 7.49 ± 0.31a | 7.61 ± 0.19a |

TABLE 5
Effects of organic fertilizer application on the growth of continuous
cropping ginseng plants in control group and Embodiments 1-3

| | Control group | Embodiment 1 | Embodiment 2 | Embodiment 3 |
|---|---|---|---|---|
| Chlorophyll (SPAD) | 33.90 ± 1.57a | 34.12 ± 0.68a | 34.28 ± 0.67a | 35.84 ± 2.34a |
| Plant height (mm) | 34.66 ± 1.32d | 53.30 ± 1.05a | 44.56 ± 1.57c | 47.41 ± 1.95b |
| Leaf weight (g/plant) | 0.14 ± 0.01b | 0.24 ± 0.03a | 0.26 ± 0.02a | 0.26 ± 0.03a |
| Root length (cm) | 11.03 ± 1.14a | 11.42 ± 0.42a | 11.59 ± 0.72a | 11.17 ± 0.51a |
| Root diameter (mm) | 4.32 ± 0.45b | 5.11 ± 0.06a | 5.17 ± 0.27a | 5.23 ± 0.33a |

Conclusion: Table 2 shows that, compared with the control group, the soil pH of Embodiments 1, 2, and 3 is significantly increased by 0.29-0.55 units, the soil bulk density is significantly decreased by 4%-11%, the soil organic carbon is significantly increased by 20%-21%, the soil available phosphorus is increased by 20%-40%, the soil rapidly available potassium is increased by 21%-36%, the soil porosity is increased by 2%-10%, the soil moisture is increased by 14%-25%, the soil electrical conductivity is increased by 27%-52%, the microbial biomass carbon is increased by 17%-24%, and the microbial biomass nitrogen is increased by 20%-35%;
as may be seen from Table 3, the effect of soil physical structure enhancement is remarkable, with a significant increase in soil aggregate fractions and an increase in the mean weight diameter of soil aggregates by 9%-24%;

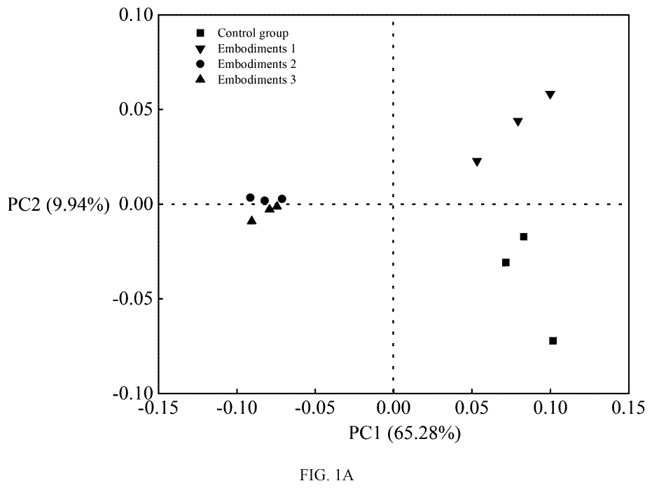

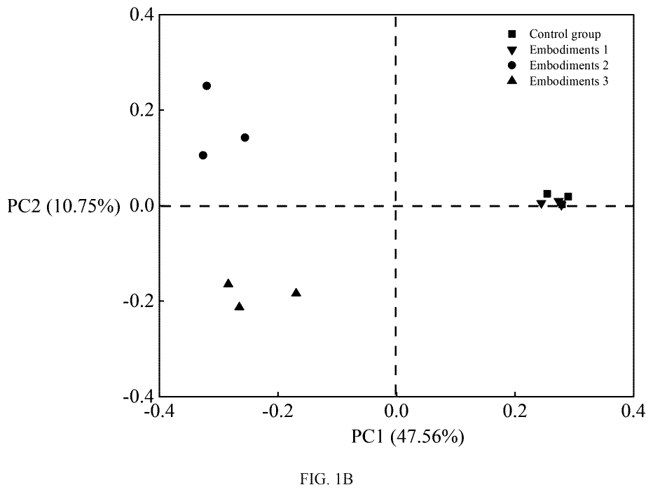

As can be seen from Table 4 and FIG. 1A and FIG. 1B (FIG. 1A shows the effects of organic fertilizers on the bacterial community structure and FIG. 1B shows the effects of organic fertilizers on the fungal community structure of continuous ginseng soils in the control group and Embodiments 1-3), the biochar-based organic fertilizers significantly increase soil microbial abundance and biodiversity, and the abundance of pathogenic microorganisms is significantly reduced. Compared with the control group, the gene copy numbers of soil bacteria and fungi are increased by 19%-38% and 17%-39%, respectively; and the relative abundance of Fusarium oxysporum, a pathogen of ginseng root rot, is reduced by 45%-52%; i.e., by applying the biochar-based organic fertilizer defined in the present disclosure, the bacterial and fungal diversity and community structure of soil may be significantly improved;
as observed from Table 5, the biochar-based organic fertilizer in Embodiments 1-3 of the present disclosure may significantly promote the growth of ginseng compared with the control group, and the plant height, leaf weight, root length and root diameter of ginseng are significantly improved;

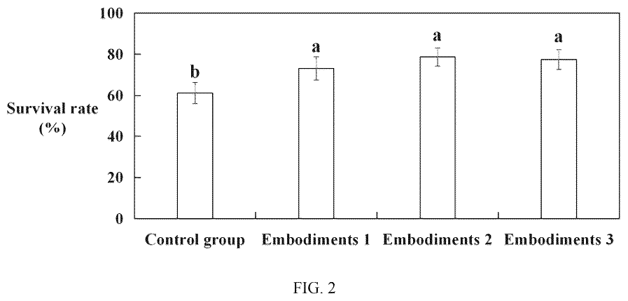

FIG. 2 shows the effect of organic fertilizers in the control group and Embodiments 1-3 on the survival rate of continuous ginseng plants, from which it is clear that the application of the organic fertilizers in Embodiments 1-3 has increased the survival rate of ginseng plants by 21%-24% compared to the application of the control group;

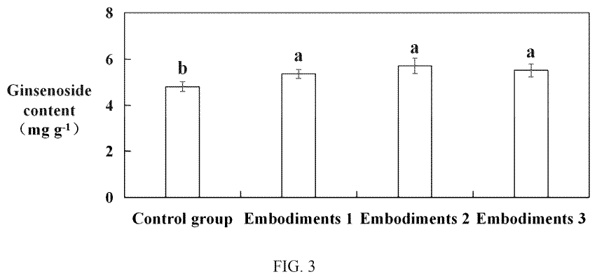

FIG. 3 shows the effect of organic fertilizer in control group and Embodiments 1-3 on the content of ginsenoside in continuous cropping. It may be seen that the quality of ginseng (saponin content) is improved by 11%-19% compared with that in control group after applying organic fertilizer in Embodiments 1-3;

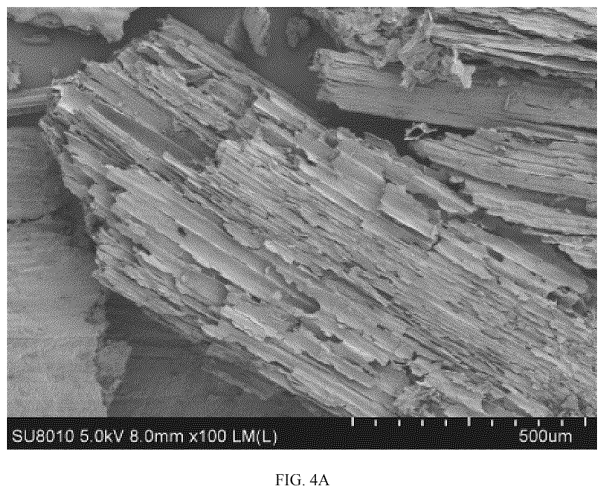

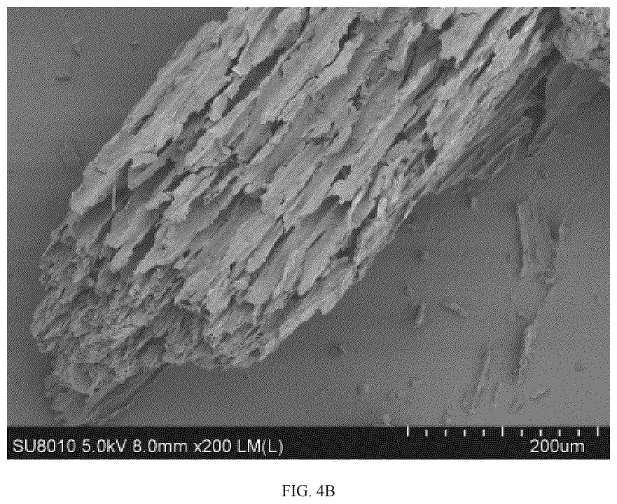

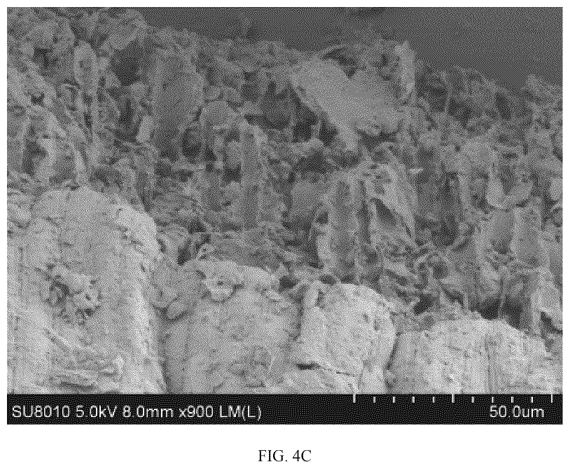

FIG. 4A, FIG. 4B and FIG. 4C are the scanning electron microscope (SEM) diagrams of biochar of corn straws prepared in Embodiment 1 of the present disclosure with scales of 500 μm, 200 μm and 50 μm, respectively. From FIG. 4A-FIG. 4C, it may be seen that the biochar of corn straws has obvious tubular structure, developed pore structure, smooth inner surface and rough outer surface; at the scale of 50 μm, it is observed that ash substances similar to mineral nutrients are distributed in pores.

The above describes only the preferred embodiments of this application, but the protection scope of this application is not limited to this. Any change or replacement that may be easily thought of by a person familiar with this technical field within the technical scope disclosed in this application should be included in the protection scope of this application. Therefore, the protection scope of this application should be based on the protection scope of the claims.

What is claimed is:

1. A biochar-based organic fertilizer, comprising raw materials of pig manure, biochar of corn straws, mixed straws, a mineral catalyst and a microbial decomposing agent.

2. The biochar-based organic fertilizer according to claim 1, wherein a mass ratio of the pig manure, the biochar of corn straws, the mixed straws, the mineral catalyst and the microbial decomposing agent is 100:(30-40):20:1:0.1.

3. The biochar-based organic fertilizer according to claim 1, wherein the mineral catalyst is fine zeolite minerals.

4. The biochar-based organic fertilizer according to claim 1, wherein preparation steps of the biochar of corn straws comprise:
subjecting corn straws to high-temperature carbonization under anaerobic conditions, cooling, grinding and sieving to obtain the biochar of corn straws.

5. The biochar-based organic fertilizer according to claim 4, wherein in a process of the high-temperature carbonization, the corn straws are heated from room temperature, at a heating rate of 5 degrees Celsius per minute, to 450 degrees Celsius, and held for 180 minutes.

6. The biochar-based organic fertilizer according to claim 4, wherein the sieving is sieving using a 10-20 mesh sieve.

7. The biochar-based organic fertilizer according to claim 1, wherein the mixed straws comprise corn straws, rice straws and wheat straws.

8. A preparation method of the biochar-based organic fertilizer, comprising following steps:
performing aerobic composting fermentation on uniformly mixed raw materials according to claim 1 to prepare the biochar-based organic fertilizer.

9. The preparation method of the biochar-based organic fertilizer according to claim 8, wherein a specific process of the aerobic composting fermentation comprises:
initial heating period, with a temperature lower than 50 degrees Celsius, and a pile is turned over every 2 days for 5-7 days;
high temperature period, where the temperature reaches 50-70 degrees Celsius, and the pile is turned over every 1-2 days for 7-12 days; and
cooling period, where the temperature is below 55 degrees Celsius, and the pile is turned every 2-3 days for 5-7 days.

10. A use method of the biochar-based organic fertilizer according to claim 1, comprising applying the biochar-based organic fertilizer to soils of a continuous cropping ginseng field at 10 tons per hektare.
